(19) United States
(12) Patent Application Publication
(10) Pub. No.: US 2017/0321837 A1
(43) Pub. Date: Nov. 9, 2017

(54) DEVICE FOR DAMPENING PRESSURE PULSATIONS IN A GAS FLOW

(71) Applicant: Nuovo Pignone Srl, Florence (IT)

(72) Inventors: Jayesh Nivrutti PATIL, Bangalore, Karnataka (IN); Fabrizio ZAGLI, Firenze, FI (IT); Marco Mark PASSERI, Firenze, Florence (IT); Luciano RANFAGNI, Firenze, FI (IT)

(21) Appl. No.: 15/525,760

(22) PCT Filed: Nov. 6, 2015
(86) PCT No.: PCT/EP2015/075959

§ 371 Date: May 10, 2017

(30) Foreign Application Priority Data
Nov. 10, 2014 (IT) MI2014A001935

(51) Int. Cl. F16L 55/04; F16L 55/027; F17D 1/20; F04B 39/00

(52) U.S. Cl. CPC F16L 55/041; F17D 1/20; F16L 55/02781; F04B 39/0072

(57) ABSTRACT

A device for dampening pressure pulsations in a gas flow including a vessel with an inlet and an outlet, the vessel defines an internal volume for the transit of the gas; a choke tube in fluid communication with the vessel and placed completely outside the internal volume of the vessel.

### FIELD OF THE INVENTION

Embodiments of the invention relate to a device for dampening pressure pulsations in a gas flow. In particular, the embodiments of the present invention disclose a device that can be used, for example, upstream or downstream of a reciprocating compressor. These arrangements can be commonly seen in natural gas compressing stations, hydrocarbon refineries, extraction wells and other places.

### BACKGROUND

As it is known in the art, when a reciprocating compressor is used to move a gas, pressure oscillation can be expected due to the reciprocating motion of the piston inside the cylinder. These oscillations have to be dampened, otherwise serious damage can result either upstream or downstream of the compressor.

In the art, a device for dampening pressure pulsations in a gas flow comprises a vessel, also known in the technical field as “empty volume bottle”, which is placed upstream and downstream each compression stage, so that the gas has to transit inside it prior to enter/outlet in the plant piping. This already allows to dampen pressure pulsations for large range of frequencies and is effective in all the cases but it may require very large volume, difficult to be fit in the system, to comply with the pressure pulsations requirements. When the operating conditions allow it the dampening device have to be tuned to the desired frequencies and in such case several elements can be added inside the vessel. A few of these known elements can be deviator, baffles or choke tubes.

These known elements can be expected to fail some time during the operating life of the device. If these elements break off from the vessel they can follow the gas flow (suction side) and damage the compressor or equipment downstream of the device (discharge side). In case of failure, being pressure vessels (i.e. subjected to several re-certification tests) a long time is necessary to restore it with consequent stop of the plant.

### SUMMARY OF INVENTION

A first embodiment of the invention relates to a device for dampening pressure pulsations in a gas flow. Such device comprises a vessel, defining an internal volume for the transit of the gas. The vessel has an inlet and an outlet. Also, the device comprises a choke tube in fluid communication with the vessel and placed completely outside the internal volume of the vessel.

In an embodiment, since the choke tube is placed outside, it cannot follow the flow of gas in the event of accidental damage. Moreover, since the tube is outside the pressure vessel equipment it can be properly supported as the rest of the piping, such event is less likely to happen.

Also, since the choke tube is placed outside the pressure vessel it can be easily replaced. This is also useful if, for example, the compressor operating conditions are modified later the manufacturing of the volume since the external choke makes it possible to “tune” again the device for the new operating conditions and frequency, just by changing the choke tube length or internal diameter.

### BRIEF DESCRIPTION OF THE DRAWINGS

Further details and specific embodiments will refer to the attached drawings, in which:

FIG. 1 is a schematic view of a device for dampening pressure pulsations in a gas flow according to a first embodiment of the present invention;

FIG. 2 is a schematic view of a device for dampening pressure pulsations in a gas flow according to a second embodiment of the present invention;

FIG. 3 is a schematic view of a device for dampening pressure pulsations in a gas flow according to a third embodiment of the present invention;

FIG. 4 is a schematic view of a device for dampening pressure pulsations in a gas flow according to a fourth embodiment of the present invention; and

FIG. 5 is a schematic representation of a plant configuration comprising the devices from FIGS. 1-4.

### DETAILED DESCRIPTION

The following description of exemplary embodiments refer to the accompanying drawings. The same reference numbers in different drawings identify the same or similar elements. The following detailed description does not limit the invention. Instead, the scope of the invention is defined by the appended claims.

Reference throughout the specification to “one embodiment” or “an embodiment” means that a particular feature, structure, or characteristic described in connection with an embodiment is included in at least one embodiment of the subject matter disclosed. Thus, the appearance of the phrases “in one embodiment” or “in an embodiment” in various places throughout the specification is not necessarily referring to the same embodiment. Further, the particular features, structures or characteristics may be combined in any suitable manner in one or more embodiments.

Therefore, a device for dampening pressure pulsations in a gas flow will be described in detail with reference to the attached drawings, where it will be indicated with the number 1.

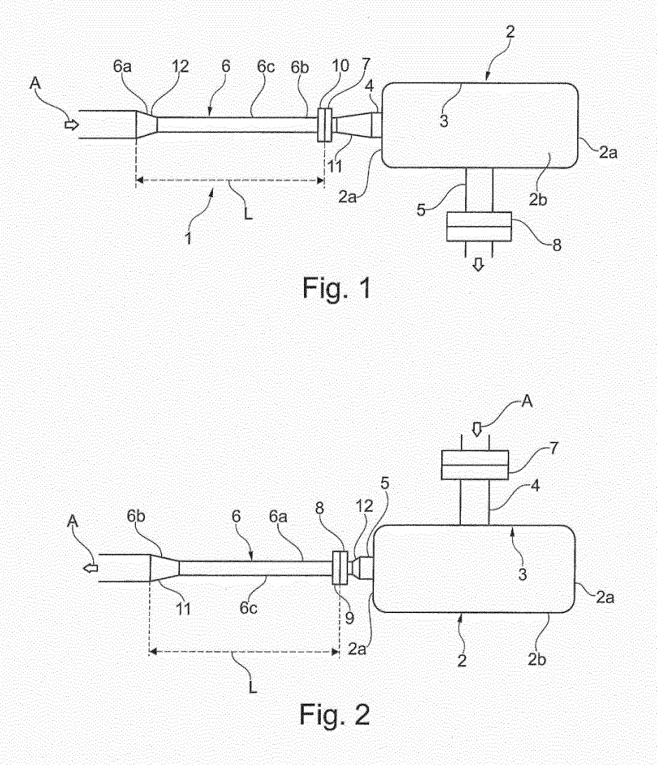

The device 1 comprises a vessel 2 in which the gas can transit. The vessel 2 defines an internal volume 3. According to the embodiments shown in FIG. 1-4 the vessel 2, and consequently the internal volume 3, are substantially cylindrical. With additional details, the vessel 2 is defined by a couple of base surfaces 2a, which is circular in an embodiment, and by a cylindrical wall 2b extending between the base surfaces 2a. A transversal section of the vessel 2 is defined as a section on a plane substantially parallel to the base surfaces 2a. The transversal section is, in an embodiment, constant along the length of the vessel 2.

With more detail, the vessel 2 has an inlet 4 and an outlet 5. Indeed, during normal functioning the gas transits through the vessel 2 from the inlet 4 to the outlet 5. This defines a flow direction “A” of the gas inside the device 1. In the embodiment of the invention shown in FIG. 1, the inlet 4 is in an embodiment placed on a base surface 2a, while the outlet 5 is placed on the cylindrical wall 2b. In the embodiment of the invention shown in FIG. 2, the inlet 4 is in an embodiment placed on the cylindrical wall 2b, while the outlet 5 is placed on one of the base surfaces 2a. In other embodiments, not shown in the drawings, the inlet 4 and the outlet 5 may be placed each on a respective base surface 2a, or they may be placed both on the cylindrical wall 2b, in an embodiment opposite to each other. With more detail, the inlet is provided with a first flange 7. Similarly, the outlet 5 is provided with a second flange 8. The use of the first 7 and of the second flange 8 will be detailed in a following part of the present disclosure.

According to an alternative embodiment of the invention, not shown in the drawings, the vessel 2 and the internal volume 3 are spherical.

A choke tube 6 is placed in fluid communication with the vessel 2. Such choke tube 2 is placed completely outside the internal volume 3 of the vessel 2.

The choke tube 6 is straight. In this way the pressure drops along the choke tube 6 are minimized, so to facilitate complying with the API 618 approach 3 values. Also, in this way the embodiments of the present invention can be employed in more application which would otherwise need to resort to the prior art of using only an empty volume bottle. Additionally, the choke tube 6 has entry portion 6a and an exit portion 6b along the above mentioned flow direction “A”.

The choke tube 6 has a central portion 6c between the entry 6a and the exit portion 6b. The intermediate portion 6c of the choke tube 6 has a constant cross-section. In other words, the diameter of the intermediate portion 6c is fixed. In the context of the present disclosure, the diameter of the choke tube 6 is defined as the diameter of the fixed portion 6c.

In an embodiment, the device 1 comprises a convergent portion 12 and a divergent portion 11 along the flow direction “A”. In detail, the convergent portion 12 is placed before the central portion 6c of the choke tube 6. The divergent portion 11 is placed after the central portion 6c of the choke tube 6.

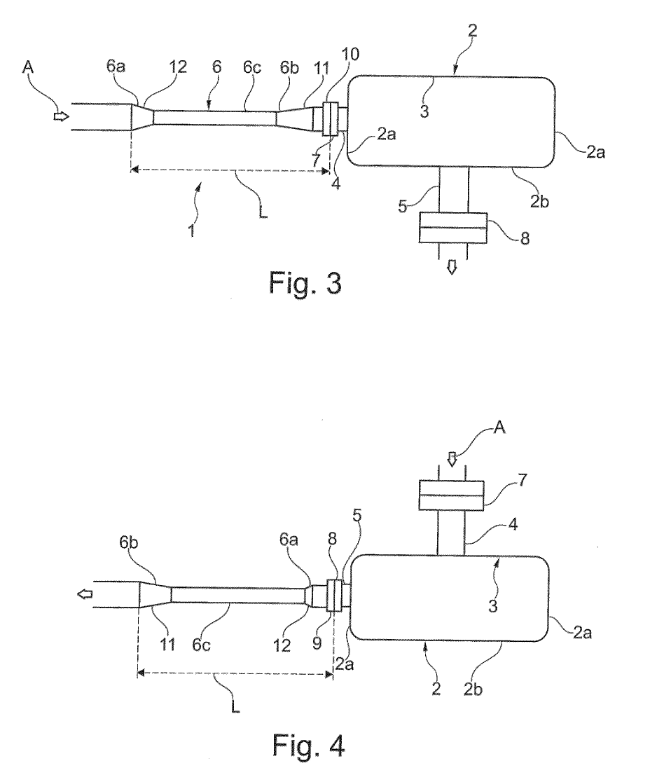

In the embodiments shown in FIGS. 1 and 3, with may be employed on the suction side of a compressor stage in at least one embodiment, the convergent portion 12 is defined by the entry portion 6a of the choke tube 6. Specifically, in the embodiment shown in FIG. 1 the divergent portion 11 forms part of the inlet 4 of the vessel 2. Also, the exit portion 6b has a constant cross section, equal to the cross-section of the central portion 6c. However, in the embodiment shown in FIG. 3 the divergent portion 11 can be defined by the exit portion 6b.

Also, in the embodiments shown in FIGS. 1 and 3 the walls of the convergent portion 12 have an inclination comprised between 20° and 40°, in some embodiments should be equal to 30°. Similarly, in some embodiments the divergent portion 11 has an inclination comprised between 10° and 20°, by way of example equal to 14°.

In the embodiments of FIGS. 2 and 4, which may be employed on the discharge side of a compressor stage, the divergent portion 11 is defined by the exit portion 6b of the choke tube 6. Specifically, in the embodiment shown in FIG. 2 the convergent portion 12 forms part of the outlet 5 of the vessel 2. Also, the entry portion 6a of the choke tube 6 has a constant cross section, in an embodiment equal to the cross-section of the central portion 6c. However, in the embodiment shown in FIG. 4 the convergent portion 12 can be defined by the entry portion 6a.

In the embodiments shown in FIGS. 2 and 4 the walls of the convergent portion 12 have an inclination comprised between 50° and 70°, in an embodiment should be equal to 60°. Similarly, in an embodiment, the divergent portion 11 has an inclination comprised between 10° and 30°, by way of example equal to 20°.

For joining with the vessel 2, the entry portion 6a may have a third flange 9. In this case, shown as part of the embodiments of FIGS. 2 and 4, the third flange 9 is configured to mate with the second flange 8 of the vessel 2.

Similarly, the exit portion 6b may have a fourth flange 10. In this case, shown as part of the embodiment of FIGS. 1 and 3, the fourth flange 10 is configured to mate with the first flange 7 of the vessel 2.

With additional detail, the length and the diameter of the choke tube 6 are determined as a predefined function of the reduction of the pressure pulsation at a chosen frequency, of the internal volume 3 and of the transversal section of the pipe upstream and/or downstream of the device 1. In particular, for the configuration of the device 1 according to embodiments of the present invention it holds the following design relationship:

$$\frac{Δ {p}_{out}}{Δ {p}_{in}} = \frac{1}{\sqrt{{[ 1 - {( \frac{ω}{{ω}_{r}} )}^{2} ]}^{2} + {( ω \frac{V}{Sa} )}^{2}}}$$

In the above equation, Δpₒᵤₜ is the pressure pulsation of the gas exiting the device 1. Similarly, Δpᵢₙ is the pressure pulsation of the gas entering the device 1. “V” is the volume inside of the vessel 2, i.e. the volume of the internal volume 3. “S” is the transversal section of the plant piping downstream of the device 1, while “a” is the speed of sound in the device 1. The parameter ωᵣ is defined as

$${ω}_{r} = a \sqrt{\frac{A}{LV}}$$

wherein A is the transverse section of the choke tube 6. L is the length of the choke tube 6.

In order to size the choke tube 6, the parameter ωᵣ is extracted from the first relationship, since all the other parameters are either known or are design objectives. The second relationship can be used to extract the size of the choke tube 6. The process can be repeated as many times as it is necessary for the frequencies which the device 1 is designed to dampen. This results in many values of length and transverse section for the choke tube 6. A suitable compromise for the actual sizing of the choke tube 6 can then be found by averaging the results in any way known to the skilled technician. Furthermore, if the exact desired value of the diameter (which defines the transverse section A) of the choke tube 6 is not commercially available the above formulas can be used to verify if a similar sized and commercially available choke tube 6 can be acceptable.

The selected choke tube layout, to be applicable, should maintain its pressure drop within acceptable limits (e.g API 618 approach 3 pressure drop limits).

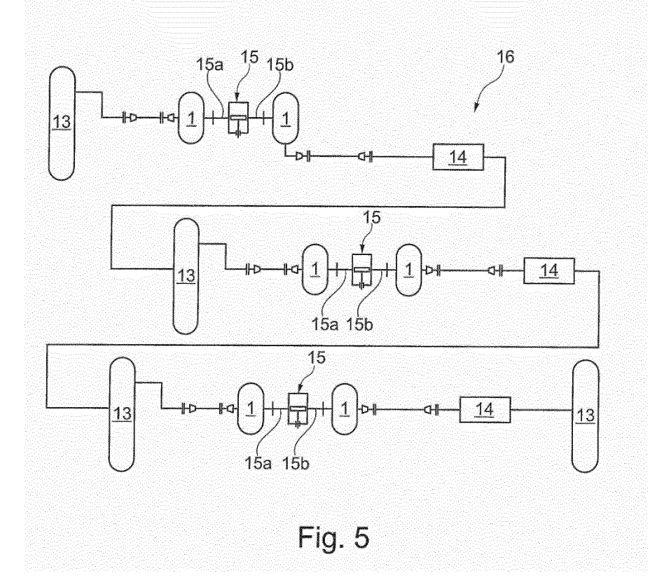

With reference to FIG. 5, another embodiment of the invention relates to an apparatus (or plant) 16 which comprises a reciprocating compressor. Such compressor comprises a plurality of stages 15. Each stage has a suction duct 15a and a discharge duct 15b for a gas flow. The stages 15 are placed in series to each other, meaning that the discharge duct of each stage is placed in fluid communication with the suction duct of the next stage. Optionally, an heat exchanger 14 can be placed between two consecutive stages. Also, a separator 13 (also called demister in the technical field) can be placed downstream of the heat exchanger 14. A device 1 for dampening pressure pulsations in a gas flow as described above can then be provided for each suction duct 15a and/or for each discharge duct 15b.

This written description uses examples to disclose the invention, including the preferred embodiments, and also to enable any person skilled in the art to practice the invention, including making and using any devices or systems and performing any incorporated methods. The patentable scope of the invention is defined by the claims, and may include other examples that occur to those skilled in the art. Such other examples are intended to be within the scope of the claims if they have structural elements that do not differ from the literal language of the claims, or if they include equivalent structural elements with insubstantial differences from the literal languages of the claims.

1. A device for dampening pressure pulsations in a gas flow comprising:
a vessel defining an internal volume for the transit of said gas, said vessel having an inlet and an outlet; a choke tube in fluid communication with the vessel and placed completely outside said internal volume of said vessel.

2. The device according to claim 1, wherein said choke tube has entry portion and an exit portion, a flow direction for the flow of the gas being defined from said entry portion to said exit portion.

3. The device according to claim 2, wherein said entry portion is convergent along said flow direction.

4. The device according to claim 2, wherein said entry portion has a constant cross-section.

5. The device according to claim 2, wherein said exit portion is divergent.

6. The device according to claim 2, wherein said exit portion has a constant cross-section.

7. The device according to claim 2, wherein said entry portion has a third flange, the outlet of the vessel having a second flange for connecting with said third flange.

8. The device according to claim 2, wherein said exit portion has a fourth flange, the inlet of the vessel having a first flange for connecting with said fourth flange.

9. The device according to claim 1, wherein said choke tube is straight.

10. The device according to claim 1, wherein said choke tube has an intermediate portion having a constant cross-section.

11. The device according to claim 1, wherein the length and the diameter of said choke tube are determined as a predefined function of the reduction of the pressure pulsation at a chosen frequency, the internal volume and the transversal section of a pipe on which the device is designed to be installed.

12. An apparatus comprising
a reciprocating compressor comprising a plurality of stages, wherein each stage having a suction duct and a discharge duct for a gas flow, the discharge duct of each stage being in fluid communication with the suction duct of the next stage; and
each suction duct and each discharge duct being provided with a respective device for dampening pressure pulsations in a gas flow a vessel defining comprising:
an internal volume for the transit of said gas, said vessel having an inlet and an outlet a choke tube in fluid communication with the vessel and placed completely outside said internal volume of said vessel.
